(19) United States
(12) Patent Application Publication
(10) Pub. No.: US 2012/0160816 A1
(43) Pub. Date: Jun. 28, 2012

(54) CUTTING APPARATUS

(76) Inventor: Anton W. HUBERT, Monchengladbach (DE)

(21) Appl. No.: 13/333,055

(22) Filed: Dec. 21, 2011

(30) Foreign Application Priority Data
Dec. 22, 2010 (DE) 20 2010 016 854.6

(51) Int. Cl. B23K 26/38

(52) U.S. Cl. 219/121.67

(57) ABSTRACT

The invention relates to a cutting apparatus. A carrying device has a carrying bar extending above the cutting table and can be moved by an undercarriage transversely to the longitudinal axis of the carrying bar parallel to the plane of the cutting table. At least one cutting carriage is guided displaceably on the carrying bar in the direction of the longitudinal axis parallel to the plane of the cutting table and on which there is positioned a cutting device for generating a cutting beam directed at the cutting table. A protective housing being provided to cover the cutting beam and encloses the cutting device on all sides and relative to which the cutting carriage can be moved. The protective housing being provided on the carrying device and being moveable over the cutting table with the carrying device.

### CROSS-REFERENCE TO RELATED APPLICATIONS AND CLAIM TO PRIORITY

This application is related to utility model 20 2010 016 854.6, filed Dec. 22, 2010, in the Federal Republic of Germany, the disclosure of which is incorporated by reference and to which priority is claimed.

### FIELD OF THE INVENTION

The invention relates to a cutting apparatus for cutting workpieces.

### BACKGROUND OF THE INVENTION

The invention relates to a cutting apparatus for cutting workpieces comprising a cutting table for holding the workpiece, comprising a carrying device which has a carrying bar extending above the cutting table and which is supported by an undercarriage to the side of the cutting table and which can be moved by the undercarriage transversely to the longitudinal axis of the carrying bar parallel to the plane of the cutting table, and comprising at least one cutting carriage which is guided displaceably on the carrying bar in the direction of the longitudinal axis of the latter parallel to the plane of the cutting table and on which there is positioned a cutting device for generating a cutting beam directed at the cutting table, a protective housing being provided to cover the cutting beam that has high side walls enclosing the cutting device on all sides and relative to which the cutting carriage can be moved.

Cutting apparatuses of the type specified above are used to cut metal plates by means of a cutting beam in order to obtain a desired form of the metal plate or to cut out a workpiece section with a specific shape. A cutting table is provided in order to support the metal plates. The cutting table is surrounded by an apparatus frame. A carrying device is supported on the apparatus frame and has a carrying bar extending above the cutting table which is supported on one side (see DE 297 22 240 U1) or on both sides (see DE 298 12 538 U1) by the apparatus frame by means of an undercarriage. The carrying device—of which there can also be several—can be moved transversely to the longitudinal axis of the carrying bar parallel to the plane of the cutting table so that one can essentially cover the whole cutting table.

A cutting carriage is guided displaceably on the carrying bar in the direction of the longitudinal axis of the latter parallel to the plane of the cutting table. There can also be a number of cutting carriages. There is disposed on each cutting carriage respectively a cutting device for generating a cutting beam directed towards the cutting table. The cutting device is height-adjustable in order to be able to set an optimum distance between the surface of the workpiece and the lower side of the cutting device for the cutting process by adapting to the thickness of the workpiece to be cut.

The movement of the carrying device and the cutting carriage during the cutting process is brought about automatically with the aid of a cutting device control means (see DE 298 12 538 U1) according to a specific sequence programme. For this purpose the undercarriage of the carrying device and that of the cutting carriage have motors which are connected to the cutting device control means.

The cutting apparatuses described above differ according to the manner of generating the cutting beam. The cutting beam can be in the form of a burning flame generated by a flame cutter and which is generated by a heating gas, for example a mixture of acetylene and oxygen. Instead of a flame cutter, other cutting beams can also be used, for example plasma cutting beams or water beam cutting beams.

Due to the development of high-energy lasers metal workpieces can also be cut by means of laser cutting beams (see DE 20 2004 021 725 U1; DE 10 2008 030 374 A1; DE 10 2008 053 729 A1). In addition to CO₂ lasers, so-called fibre lasers can also be used. The latter are a special form of solid state lasers with which the doped core of a glass fibre forms the active medium. Due to the great length of such glass fibres, a high level of strengthening is achieved (see the website under the wikipedia.de domain, heading “Faserlaser” (“Fibre Lasers”), accessed on 4 Nov. 2010; DE 10 2007 049 436 B4).

With cutting apparatuses of the type specified above it is essential to avoid direct eye contact between the cutting beam and the operator. This applies in particular to flame cutting apparatuses with a burning flame as a cutting beam. Protection is mostly provided by a protective cover tightly surrounding the cutting beam on the cutting device itself. This is generally sufficient for the aforementioned cutting apparatuses.

With laser cutting devices, in particular those which are equipped with a fibre laser, there is an increased need for protection because laser beams are reflected by the surface of the workpiece to be cut, and the reflected beams still have so much energy that injuries, in particular to the eyes of the operator, can occur. In order to be sure in this respect, it is known in the prior art to surround such cutting apparatuses with a protective housing that is positioned stationarily and thus surrounds the whole apparatus frame of the cutting apparatus with high side walls on all sides, mostly further supplemented by top and bottom walls (see the website under the wikipedia.de domain, heading “Laserschneiden” (“laser cutting”), accessed on 4 Nov. 2010). The protective housing also contains reflected cutting beam components and thus prevents an operator located outside of the protective housing from being exposed to the cutting beam or beam portions reflected from the latter.

Such a protective housing takes up more space. Moreover, due to the large areas of the walls of the protective housing it is expensive. For loading and unloading with the workpiece to be cut parts of the protective housing must be removed and then refitted. Not only is this laborious, but it also results in the cutting apparatus meanwhile being at a standstill, i.e. the existing downtimes for loading and unloading with the workpiece are extended.

### SUMMARY OF THE INVENTION

The object forming the basis of the invention is to design a cutting apparatus of the type described above such that it is less expensive to produce and takes up less space, and with which the downtimes for loading and unloading the workpiece to be cut are considerably reduced.

This object is achieved according to the invention in that the protective housing is provided on the carrying device and can be moved over the cutting table with the carrying device. It is therefore the basic idea of the invention to provide the protective housing, that is intended to protect an operator against the direct or indirect effect of the cutting beam, on the carrying device, i.e. to attach it to the latter so that the protective housing is reduced to the area of the carrying device and is moved with the latter over the cutting table. It has no additional floor space requirement, and so the cutting apparatus can also be set up in cramped conditions. Since considerably smaller housing surfaces are required for the protective housing it is less expensive to produce. For loading and unloading the workpiece to be cut there is no need to dismantle parts of the protective housing. The downtimes of a cutting device are correspondingly short according to the present invention.

A cutting apparatus of the type according to the invention is suitable for cutting devices with all types of cutting beams. The extension of the side walls of the protective housing can then be adapted to the respective protection requirements and to the characteristics of the cutting beam. Therefore, the cutting apparatus is also suitable for laser cutting devices, and in particular for fibre laser cutting devices. With these devices too reliable containment of reflected cutting beam portions is made possible by corresponding surface extensions of the side walls of the protective housing.

The design according to the invention of the protective housing is not only suitable for carrying bars which are supported at both ends by carrying columns on carriers of the undercarriage, but also for those with which the carrying bar is only supported on one end (see DE 297 22 340 U1).

The configuration of the invention makes provision such that the carrying device can be moved such that it can be brought together with the protective housing outside of the region of the cutting table. By tightly enclosing with the protective housing an extension of the apparatus frame is not required for this purpose. Since in this position of the carrying device the cutting table is totally open to the top, it can be loaded and unloaded with the workpiece from the top, and this is quick and easy to implement.

The protective housing should extend at least essentially over the whole length of the carrying bar so that the moveability of the cutting carriage is not affected by the protective housing, and in fact the cutting carriage can be moved over the whole length of the carrying device.

According to a further feature of the invention it is proposed that the protective housing is guided moveably at least partially relative to the carrying bars between a lowered protective position and a raised fitting position. Upon the basis of this design of at least part of the protective housing access to the cutting device located within the protective housing and also to the guide devices on the carrying bar is possible. In this way repair of the parts covered by the protective housing is facilitated, even in the case where the protective housing is open to the top. In so far as partial raising of the protective housing is provided, the moveable part of the protective housing should be provided where, after raising into the fitting position, easy access should be guaranteed for frequently exchangeable or frequently maintained parts of the cutting device, cutting carriage and carrying bar.

In order to keep the gap between the lower edge of the protective housing and the workpiece respectively located on the cutting table as small as possible and to be able to adapt to the thickness of the workpiece, the protective position should be height-adjustable. It goes without saying that a motorised drive device should be provided in order to move the protective housing and the moveable part of the latter. Electric motors, but also hydraulic and pneumatic cylinders, can be used as a motorised drive device.

The protective housing can have a front side wall extending between the ends of the carrying bar and which is guided moveably at least partially relative to the carrying bar between a lowered protective position and a raised fitting position. If the cutting device is not positioned exactly beneath the carrying bar, the front side wall extends on the side of the carrying bar on which the cutting device is also positioned. In this way good accessibility is obtained for the cutting device. The front side wall can be guided displaceably with its side ends on adjacent sections of the protective housing.

With a further feature of the invention provision is made such that the protective housing has in the region of the ends of the carrying bar end side walls which are connected on the front side by a front side wall and on the rear side by a rear side wall. In this way compact enveloping of the region of the carrying bar, the cutting carriage and the cutting device is produced.

In order to be able to contain reflected beam portions well at least the front side wall should have a lower wall section which extends upwards, initially at an angle, away from the carrying bar, and there should be adjoining this lower wall section an upper wall section which extends upwards in the opposite direction at an angle. A mirror image design can then be provided for the rear side wall.

As regards the end side wall, the latter can be part of the carrying columns on which the carrying bar is supported. On the lower side the end side walls can run in covering strips which partially encompass tracks for the undercarriage.

In a manner known in its own right the cutting device itself can be surrounded, at least in the region of the outlet for the cutting beam, by a protective cover which is attached to the cutting device. The protective cover serves to form a first protective barrier for the cutting beam. In order to be able to provide changes or repairs to the cutting device, it should be possible to open the protective cover.

### BRIEF DESCRIPTION OF THE DRAWINGS

In the drawings the invention is illustrated in greater detail using an exemplary embodiment. These show as follows:

FIG. 1 a view of the cutting apparatus according to the invention, at an angle from above;

FIG. 2 the same view as according to FIG. 1 with the front side wall of the protective housing raised, and

FIG. 3 a detailed view of the cutting apparatus according to FIGS. 1 and 2 with the front side wall raised and the protective cover of the cutting device folded back.

### DETAILED DESCRIPTION OF THE PREFERRED EMBODIMENTS

The cutting apparatus 1 shown in the Figures comprises an apparatus frame 2 that consists of a lower frame part 3 and an upper frame part 4 placed on the lower frame part 3. The lower frame part 3 has two longitudinal carriers 5, 6 extending parallel to one another and horizontally, on the ends of which and in the centre of which there is respectively disposed a foot block 8 to 12. The apparatus frame 2 rests by means of the foot blocks 8 to 12 on a base (not detailed here). The foot blocks 8, 10 on the front ends and the foot blocks 9, 12 on the rear ends of the longitudinal carriers 5, 6 are connected by means of cross members 13, 14.

The upper frame part 4 also has two longitudinal carriers 15, 16, that extend parallel to one another and horizontally above the longitudinal carriers 5, 6 of the lower frame part 3 and are supported by the latter. The ends of the longitudinal carriers 15, 16 of the upper frame part 4 are likewise connected by means of cross members 17, 18.

Within the space enclosed by the apparatus frame 2 a rectangular cutting table 19 is securely positioned in the front region of the cutting apparatus 1. It rests on a pedestal 20. Its upper side is formed by a table grate 21 the upper side of which extends horizontally. Workpieces to be cut, for example plates or the like, can be placed on the cutting table 19, if necessary being fixed.

There is placed on the upper frame part 4 a carrying device 22 which has a carrying bar 23 extending horizontally and parallel to the cross members 13, 14 and 17, 18 on the ends of which plate-shaped carrying supports 24, 25 engage which have on their lower side carriers 26 (not detailed here. The carriers 26 are supported by tracks on the longitudinal carriers 15, 16 so that the carrying device 22, i.e. the carrying bar 23 and the carrying supports 24, 25, can be moved along the longitudinal carriers 15, 16, i.e. transversely to the longitudinal extension of the carrying bar 23.

The undercarriage is driven on both sides by linear motors. For this purpose two rows of magnets 27, 28 arranged one over the other are respectively provided in the outsides of the upper longitudinal carriers 15, 16 and extend along the longitudinal carriers 15, 16, and a linear motor shoe (not detailed here) engages between said rows of magnets. By activating correspondingly the carrying device 22 can be moved in the direction of the longitudinal carriers 15, 16.

The carrying device 22 is surrounded by a protective housing 29. The protective housing 29 has a front side wall 30 and a rear side wall 31. Both extend over the whole length of the carrying bar 23. They have lower wall sections 32 and 33 which extend upwards at an angle from their lower edges and thereby move away from the carrying bar 23. There are adjoining these lower wall sections 32, 33 upper wall sections 34 and 35 which extend upwards at an angle and thereby approach the carrying bar 23, i.e. extend at an angle in the opposite direction. Adjoining the latter in turn are horizontal wall sections 36 and 37 at the top. The protective housing 29 is open at the top and at the bottom.

End side walls 38, 39 are attached to the carrying supports 24, 25. There are attached to the lower sides of the latter covering strips 40, 41 which encompass the outer upper edges of the longitudinal carriers 15, 16 so that no diverted cutting beam portions can occur here.

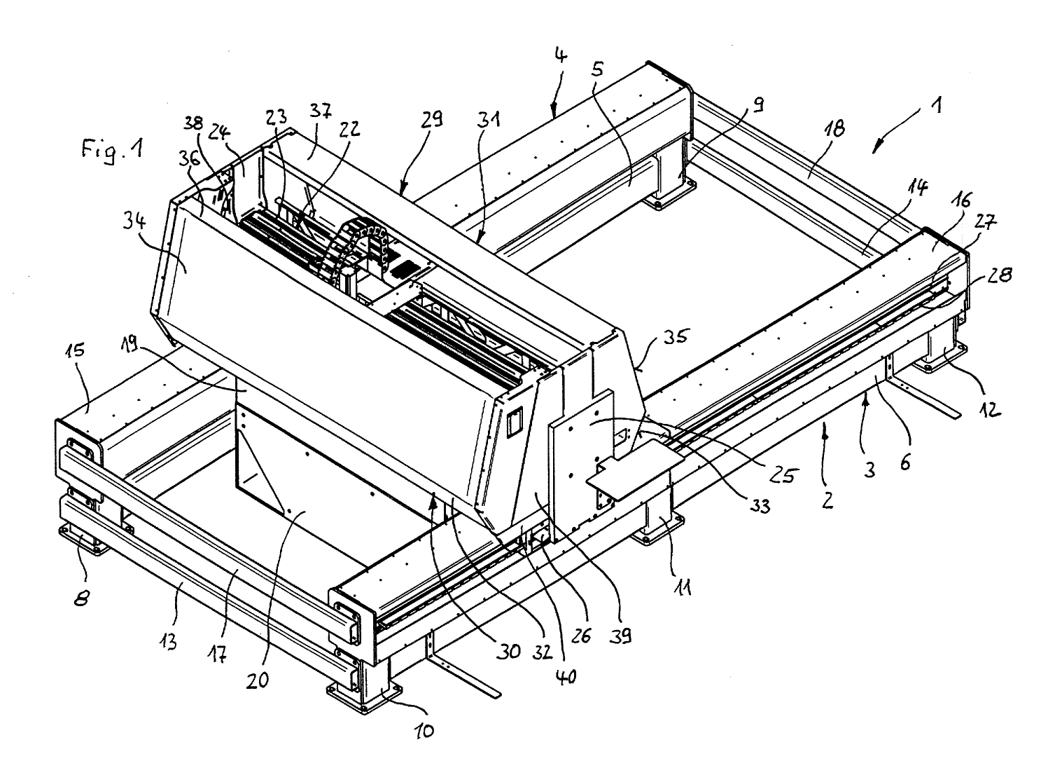

In the illustration according to FIG. 1 the front side wall 30 is in the lower protective position. This protective position is set during operation such that the lower edge of the front side wall 30 is located the smallest possible distance away above the upper side of the workpiece located on the cutting table 19. The protective position can therefore be adapted appropriately to the respective thickness of the workpiece.

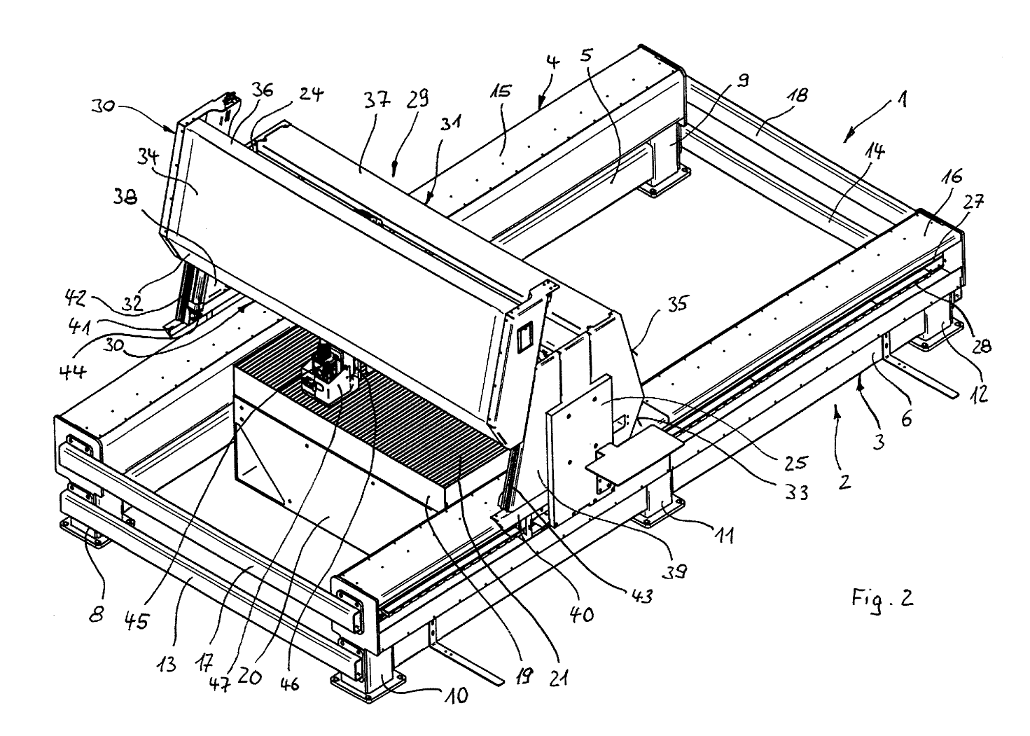

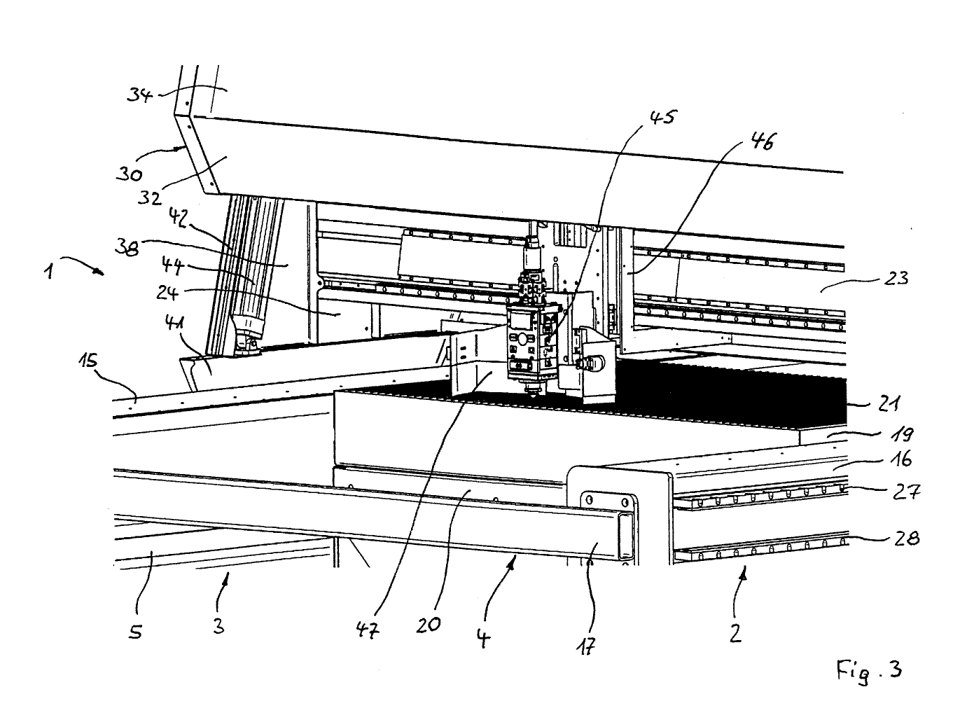

On the front edges of the end side walls 38, 39 the front side wall 30 is moved over tracks 42, 43 with vertical and angled displacement. In the illustrations according to FIGS. 2 and 3 the front side wall 30 is shown raised out of the protective position into a fitting position with the aid of pneumatic cylinders 44 arranged in parallel and on the inside next to the tracks 42, 43. In this position a cutting device 45 is exposed which is in the form of a fibre laser cutting device. The cutting device 45 is mounted on a cutting carriage 46 with vertical displacement. The latter can in turn be moved horizontally on the carrying bar 23 in the longitudinal direction of the latter with the aid of a corresponding drive motor. Due to the vertical moveability of the cutting device 45 the distance of the latter from the surface of the workpiece located on the cutting table 19 can respectively be set optimally according to the thickness of the latter. With the raised position of the front side wall 30 the essential parts of the cutting device 45 and the cutting carriage 46 can easily be reached.

In the illustration according to FIG. 2 the cutting device 45 is surrounded by a protective cover 47 the lower edge of which lies in a plane which with corresponding vertical positioning of the cutting device 45 lies as close as possible to the upper side of the workpiece located on the cutting table 19. As can be seen from FIG. 3, the protective cover 47 can be folded back so that the cutting device 45 can be made easily accessible for repair and adjustment.

Since the protective housing 29 is securely connected to the carrying device 22 it is moved with this carrying device 22 when the latter is moved along the longitudinal carriers 15, 16. For loading and unloading the cutting table 19 with a workpiece the unit is moved out of the carrying device 22 and the protective housing 29 into the rear (right-hand) region so that the cutting table 19 is then totally exposed and can easily be loaded or unloaded vertically with a workpiece.

I claim:

1. A cutting apparatus (1) for cutting workpieces comprising a cutting table (19) for holding the workpiece, comprising a carrying device (22) which has a carrying bar (23) extending above the cutting table (19) and which is supported by an undercarriage (26) to the side of the cutting table (19) and which can be moved by the undercarriage (26) transversely to the longitudinal axis of the carrying bar (23) parallel to the plane of the cutting table (19), and comprising at least one cutting carriage (46) which is guided displaceably on the carrying bar (23) in the direction of the longitudinal axis of the latter parallel to the plane of the cutting table (19) and on which there is positioned a cutting device (45) for generating a cutting beam directed at the cutting table (19), a protective housing (29) being provided to cover the cutting beam that has high side walls (30, 31, 38, 39) enclosing the cutting device (45) on all sides and relative to which the cutting carriage (46) can be moved, characterised in that the protective housing (29) is provided on the carrying device (22) and can be moved over the cutting table (19) with the carrying device (22).

2. The cutting apparatus according to claim 1, characterised in that the cutting device (45) is in the form of a laser cutting device, in particular a fibre laser cutting device.

3. The cutting apparatus according to claim 1, characterised in that the carrying device (22) can be moved such that it can be brought together with the protective housing (29) into a position outside of the region of the cutting table (19).

4. The cutting apparatus according to claim 1, characterised in that the carrying bar (23) is supported at both ends by carrying columns (24, 25) on carriers (26) of the undercarriage.

5. The cutting apparatus according to any of claim 1, characterised in that the protective housing (29) extends at least essentially over the whole length of the carrying bar (23).

6. The cutting apparatus according to claim 1, characterised in that the protective housing (29) is guided moveably at least partially relative to the carrying bar (23) between a lowered protective position and a raised fitting position.

7. The cutting apparatus according to claim 6, characterised in that the protective position is height-adjustable.

8. The cutting apparatus according to claim 6, characterised in that a motorised drive device (44) is provided in order to move the protective housing (29) and the moveable part (30) of the latter.

9. The cutting apparatus according to claim 1, characterised in that the protective housing (29) has a front side wall (30) extending between the ends of the carrying bar (23) and which is guided moveably at least partially relative to the carrying bar (23) between a lowered protective position and a raised fitting position.

10. The cutting apparatus according to claim 9, characterised in that the front side wall (30) is guided displaceably (30) with its side ends on adjacent sections of the protective housing (29).

11. The protective housing according to claim 1, characterised in that the protective housing (29) has in the region of the ends of the carrying bar (23) end side walls (38, 39) which are connected on the front side by a front side wall (30) and on the rear side by a rear side wall (31).

12. The cutting apparatus according to claim 8, characterised in that at least the front side wall (30) has a lower wall section (32) which extends upwards, initially at an angle, away from the carrying bar (23), and that there is adjoining this lower wall section (32) an upper wall section (34) which extends upwards in the opposite direction at an angle.

13. The cutting apparatus according to claim 11, characterised in that parts of the end side walls (38, 39) are carrying columns (24, 25) on which the carrying bar (23) is supported.

14. The cutting apparatus according to claim 11, characterised in that the end side wall (38, 39) runs in covering strips (40, 41) on the lower side.

15. The cutting apparatus according to claim 1, characterised in that the cutting device (45) is surrounded, at least in the region of the outlet for the cutting beam, by a protective cover (47) which is attached to the cutting device (45).

16. The cutting apparatus according to claim 15, characterised in that the protective cover (47) can be opened.

17. The cutting apparatus according to claim 2, characterised in that the carrying device (22) can be moved such that it can be brought together with the protective housing (29) into a position outside of the region of the cutting table (19).

18. The cutting apparatus according to claim 2, characterised in that the carrying bar (23) is supported at both ends by carrying columns (24, 25) on carriers (26) of the undercarriage.

19. The cutting apparatus according to claim 3, characterised in that the carrying bar (23) is supported at both ends by carrying columns (24, 25) on carriers (26) of the undercarriage.

20. The cutting apparatus according to claim 2, characterised in that the protective housing (29) extends at least essentially over the whole length of the carrying bar (23).
